(19) United States
(12) Patent Application Publication
(10) Pub. No.: US 2011/0246221 A1
(43) Pub. Date: Oct. 6, 2011

(54) Medication Administration And Patient Health Management Strategies, And Systems For Same

(75) Inventors: L. Jean Camp, Bloomington, IN (US); Kurt Weisman, Bloomington, IN (US); Shaun McDermott, Bloomington, IN (US)

(73) Assignee: INDIANA RESEARCH AND TECHNOLOGY CORPORATION, Bloomington, IN (US)

(21) Appl. No.: 13/075,546

(22) Filed: Mar. 30, 2011

Related U.S. Application Data
(60) Provisional application No. 61/318,921, filed on Mar. 30, 2010.

(51) Int. Cl. G06Q 50/00

(52) U.S. Cl. 705/2

(57) ABSTRACT

A patient health management system includes a personal computing system having a computer readable memory storing computer executable code. The system further includes a microprocessor configured to execute the computer executable code and compare stored medication library data with image data associated with a digital image of a medication captured by a digital imaging device of the personal computing system. The microprocessor is further configured to link profile data for a patient-user of the personal computing system with identification data for the medication and output an administration confirmation request based on the linked data. The administration confirmation request may include a wireless signal transmitted to a remote computing system to enable a remote computer or a health services provider to confirm that planned self-administration of medication by a patient is correct. Pharmacy errors, potential medication interaction, and other conflicts may be proactively addressed, and the patient may be alerted via signals sent to a personal communication device. Action conditions other than potential conflicts may also be detected and addressed, such as suitability for patient participation in clinical research studies.

### CROSS REFERENCE TO RELATED APPLICATIONS

This Applications claims the benefit of the filing date of U.S. Provisional Patent Application Ser. No. 61/318,921, filed Mar. 30, 2010.

### TECHNICAL FIELD

The present disclosure relates generally to managing and monitoring patient activities and health information, and relates more particularly to systems and strategies for gathering and processing medication image data.

### BACKGROUND

Many individuals around the world regularly take at least one prescription or over the counter medication. For individuals in westernized countries, it is not uncommon for medications to be taken continuously for decades. Remembering to take one indicated medication on a regular basis can be difficult enough, let alone remembering to take multiple different medications under different conditions. The case of an older individual tasked with taking a group of different morning pills and evening pills, some on an empty stomach, others with food, will be familiar to most. Compounding the challenges in organizing and remembering what medications to take and when to take them are differences in medication appearance from one manufacturer to another, differences in medication color or configuration between generics and brand names, and even changes made by a particular manufacturer to a particular pill from one year to the next. In some instances, a generic medication may contain a different proportion of certain compounds than a similar branded medication. Different amounts of acetaminophen in certain branded medications versus a supposedly equivalent generic are one example. In conjunction with the possibility of prescribing errors and pharmacy errors, proper management of self-administration of medication has become a daunting task for many.

The foregoing issues may be thought of as the “patient side” of managing the administration of medication. Hospitals, nursing homes and other clinical settings have their own set of medication administration management challenges. A typical hospital can include hundreds or thousands of resident patients, each requiring a differing medication administration profile. Databases and laptop computers storing medication and health management profiles for each resident patient, ID wristbands, and other strategies have been implemented in modern hospitals in an attempt to render appropriate and competent medication care. The reliability of medication administration whether on the “patient side” or the “caregiver side,” however, still tends to hinge upon judgment and is subject to human error.

The present disclosure addresses one or more of the problems or shortcomings set forth above.

### SUMMARY

In one aspect, a method of managing patient self-administration of medication includes receiving image data associated with an image of a medication captured by a digital imaging device of a personal computing system. The method further includes comparing the image data with stored medication library data, and linking profile data for a patient-user of the personal computing system with identification data for the medication, responsive to comparing the image data. The method still further includes outputting an administration confirmation request from the personal computing system which is based on the linked data.

In another aspect, a method of managing patient health information includes capturing a digital image of a medication via an imaging device resident on a personal communication device, and outputting a medication information signal responsive to capturing the digital image, via a microprocessor resident on the personal communication device. The method further includes determining an action condition exists responsive to the medication information signal, and generating a patient alert via the personal communication device responsive to a determined action condition.

In still another aspect, a patient health management system includes a personal computing system having a transceiver configured to receive and transmit signals with a communications network, a digital imaging device, and a microprocessor in control communication with the transceiver and the digital imaging device. The personal computing system further includes a computer readable memory storing computer executable code comprising a medication management routine. The microprocessor is configured to store medication library data on the computer readable memory, and configured via executing the medication management routine to compare the medication library data with image data associated with a digital image of a medication captured by the digital imaging device. The microprocessor is still further configured to link profile data for a patient-user of the personal computing system with identification data for the medication, responsive to comparing the medication library data with the image data, and output an administration confirmation request via the transceiver which is based on the linked data.

### BRIEF DESCRIPTION OF THE DRAWINGS

FIG. 1 is a diagrammatic view of a patient health management system according to one embodiment;

FIG. 2 is a pictorial flowchart illustrating a medication administration management process according to one embodiment;

FIG. 3 is a flowchart illustrating a patient health information management process, according to one embodiment;

FIG. 4 is a flowchart illustrating a patient health information management process according to one embodiment;

FIG. 5 is a flowchart illustrating a patient health information management process, according to one embodiment; and

FIG. 6 is a flowchart illustrating a patient health information management process, according to one embodiment.

### DETAILED DESCRIPTION

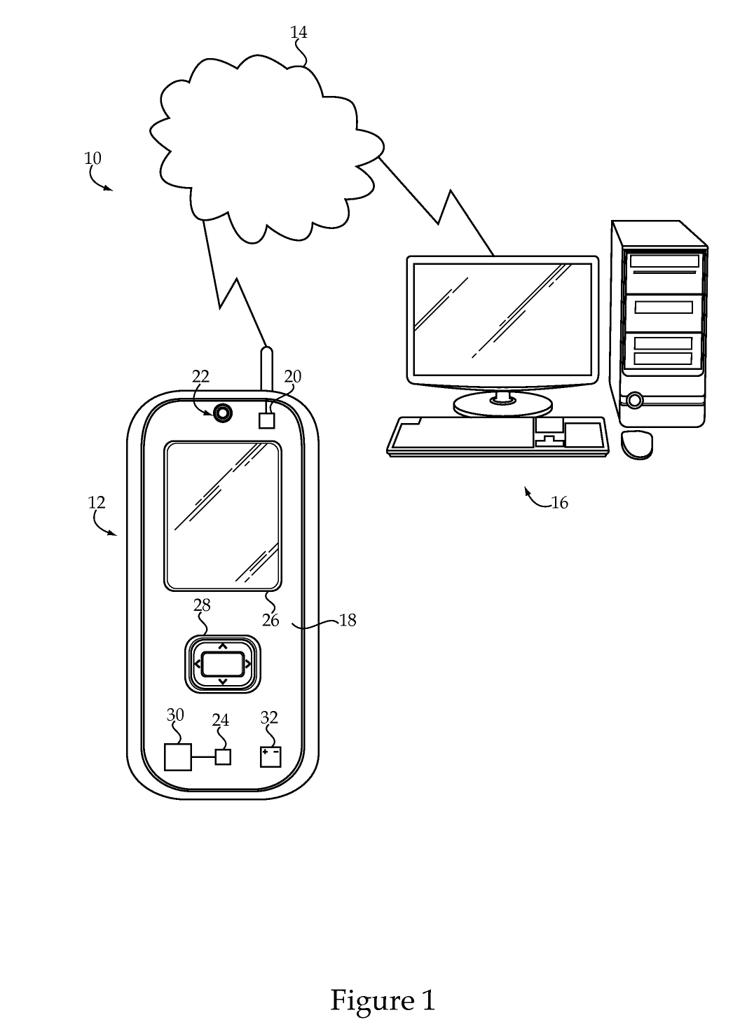

Referring to FIG. 1, there is shown a patient health management system 10 having a personal computing system 12, a remote computing system 16, and a communications network 14. Personal computing system 12 may include a computing system used by a patient, whereas remote computing system 16 may include a computing system of a health services provider such as a hospital, clinic, physician, or pharmacy. Communications network 14 may include a public or private wired or wireless communications network, the details of which are well known and not further described herein.

In one embodiment, personal computing system 12 may include a personal communications device such as a wireless phone. Personal computing system 12 may be configured by way of specialized software and/or hardware to perform or assist in performing various functions useful to acquiring, managing, and monitoring patient health information such as medication information. Rather than a personal communication device, personal computing system 12 might instead include a desktop or laptop computer, or still another device. In one practical implementation strategy, personal computing system 12 may include a wireless phone having a conventional design and hardware configuration but for software stored on the wireless phone and utilized by a patient-user or other party according to the illustrative embodiments described herein.

Personal computing system, hereinafter “device 12,” may include a housing 18 having a transceiver 20 such as a wireless transceiver positioned within or on housing 18 and configured to receive and transmit signals such as wireless signals with communications network 14. Device 12 may further include a digital imaging device 22 resident on or within housing 18, and a microprocessor 24 in control communication with transceiver 20 and digital imaging device 22. Digital imaging device 22 may include a digital camera resident on device 12. Alternatives are contemplated such as a scanner or non-resident digital camera, which includes a data link with microprocessor 24. Device 12 may further include a display 26 such as a liquid crystal or LED display or the like, controllably coupled with microprocessor 24 and configured to display images, text communications, icons, or other information via receipt of display signals from microprocessor 24. Display 26 might also include a touch-activated mechanism such that a patient-user of device 12 can enter information, respond to queries, or otherwise interact with device 12 and other systems in communication with device 12 via display 26. Device 12 may further include a control device such as a control wheel, touch pad, keypad, or any other manual navigation and information entering device 28. Device 12 might also be equipped with a microphone and speaker to enable voice interaction and control in certain embodiments. A conventional rechargeable battery 32 may be positioned within housing 18 and configured to provide electrical power for controlling and executing the various functions performed by device 12, as further described herein.

Device 12 may further include a computer readable memory 30 storing computer executable code, resident on device 12. Memory 30 may include any suitable computer readable memory such as a hard drive, flash drive, RAM, ROM, etc. Microprocessor 24 may comprise both of a memory reading device, and a memory writing device configured to store data on computer readable memory 30. Microprocessor 24 may also be configured to execute the computer executable code stored on memory 30, the significance of which will be further apparent from the following description.

Microprocessor 24 may be configured to store a variety of types of information on memory 30, including patient profile data which is specific to a patient-user of device 12. Such patient profile data may include patient health related data such as types of medication prescribed to the patient-user, dosages of the prescribed medication, and types or dosages of over the counter medication used by the patient. Such patient profile data may also include data other than medication data, such as dietary patterns suggested by a health services provider or self-reported by the patient, dietary restrictions, exercise patterns suggested by a health services provider or self-reported, exercise restrictions, specific medical conditions such as diabetes or heart conditions, allergies, patient age, gender, height and weight, family medical history, and essentially any other type of information which can be imagined which is considered specific to an individual patient. Patient profile data may be manually entered by a patient using device 28, or it might be received via transceiver 20, and recorded on memory 30 via microprocessor 24.

Device 12 may also be configured to store patient profile data which includes current location data, patient activity data, exercise data, dietary data, medication administration data, and histories of each of these types of information. For example, as further described herein, a patient-user device 12 may enter the food and water they have consumed in a given time period, times at which they consume prescribed medication or over the counter medication, exercise time, intensity and/or duration, exercise type. Stored data could still further include data as to what a patient did during a certain time period, and even how they subjectively feel. The patient-user may also be prompted to enter and/or update the stored data periodically, or at times determined to be appropriate by microprocessor 24, as further described herein. In the foregoing general manner, a continuously or regularly updated profile of a patient-user of device 12 with regard to health related information may be maintained.

Microprocessor 24 may further be configured to store data on memory 30 which is not specific to a patient-user of device 12 such as medication library data. The medication library data may include a variety of different types of information related to a variety of different types of medication, including over the counter medications and prescription medications. In one embodiment, the stored medication library data may include image data associated with images of medication for which the patient-user has a prescription, or image data associated with images of over the counter medication which the patient-user is expected or authorized by a health services provider to take.

The medication library data may also include drug interaction data for specified medications, data as to usual or permitted dosage, data as to the identity of the manufacturer of certain medications, and essentially any other data which may be associated with specific forms of medication. The United States Food and Drug Administration (FDA) maintains publicly available databases containing information specific to virtually all commonly used medications, available for download on the World Wide Web at www.fda.gov. The FDA databases are periodically updated. Other publicly available resources are known. Accordingly, device 12 may receive and store medication library data from public or private sources for use in patient health management and medication administration management or monitoring strategies as further described herein.

Storing and/or updating medication library data might take place in a manner transparent to the patient-user of device 12, or it might take place by prompting the patient-user to either enter information into device 12, or to activate an automated updating routine. In one embodiment, a patient may capture a digital image of a newly prescribed medication with imaging device 22. The captured image might then be uploaded to a remote server and library data for each of a plurality of medications considered a likely match based on the captured digital image downloaded to device 12 and stored on memory 30. Subsequent processing of image data for medications prescribed to the patient could be based on thusly stored library data. For instance, each time a patient-user of device 12 fills a prescription he/she might capture an image of one pill of the prescribed medication, and confirm whether the prescription is correct based on the previously stored library data according to the processes further described herein. When a new medication is prescribed, or for other purposes such as issuance of a recall, additional library data may be obtained.

It will be recalled that memory 30 may store computer executable code. In one embodiment, the stored computer executable code may include a medication management routine. Microprocessor 24 may be configured via executing the medication management routine to compare stored medication library data with image data associated with a digital image of a medication captured by digital imaging device 22.

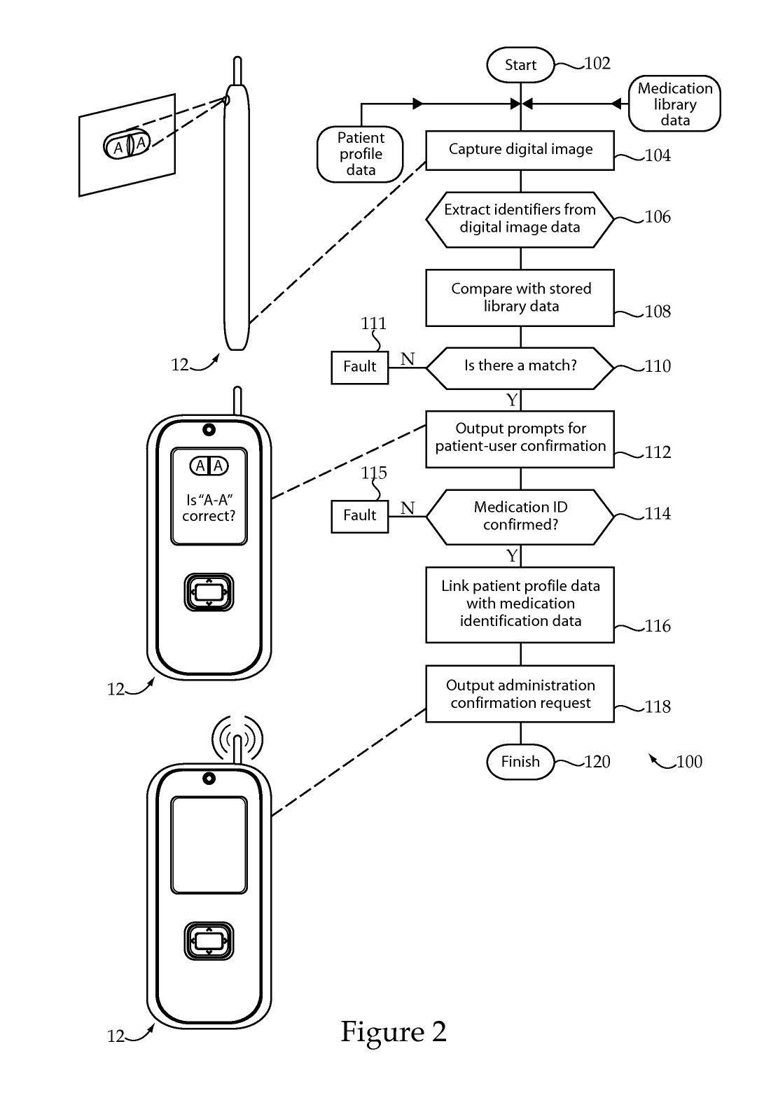

Referring to FIG. 2, there is shown a flowchart 100 illustrating one example method of managing patient self-administration of medication, corresponding to execution of a medication management routine stored on memory 30. The process of flowchart 100 may begin at a start or initialize step 102. It will be recalled that both patient profile data and medication library data may be stored on memory 30, and accordingly the method illustrated in FIG. 2 may include processing steps which utilize the stored patient profile data and medication library data as further described herein. From step 102, the process may proceed to step 104 to capture a digital image of a medication with digital imaging device 22. Step 104 may be performed manually by a patient-user of device 12, such as by actuating control mechanism 28. Image data corresponding to the captured digital image may be stored on memory 30. Those skilled in the art will appreciate that over the counter and prescription medications commonly include a number of different features which serve as contextual identifiers to indicate an identity of a medication to health services providers and patients. Features such as size, shape, color, scoring, logos and lettering, enable a person to visually determine a medication type. In some instances contextual identifiers also indicate characteristics such as dosage. Trained health services providers are typically capable of relatively rapidly visually identifying medication type, and where appropriate medication dosage, based on such contextual information. It is well known, however, that medication identification in this manner is not without shortcomings. Pharmacists or other health services providers may misidentify medication, and in some instances provide a patient with the wrong dose of a particular medication or provide them the incorrect medication altogether. Consequences of such errors need no further explanation.

The present disclosure is directed in part to reducing the incidence of medication identification errors by health services providers and patients, goals which are achieved at least in part by implementing a computer based identification process supplemented by interaction with the patient-user of device 12. As discussed above, a variety of contextual identifiers may be used in identifying medication and communicating its characteristics such as dosage. The present disclosure contemplates electronically identifying medication by way of such contextual identifiers. From step 104, the process of flowchart 100 may proceed to step 106 wherein microprocessor 24 receives image data associated with an image of a medication captured by digital imaging device 22, and extracts contextual identifiers from the digital image data. The extracted identifiers might include a medication size datum, a medication color datum, a medication scoring datum, a medication logo datum, a medication shape datum, and possibly others. From step 106, the process of flowchart may proceed to step 108 wherein microprocessor 24 may electronically read the locally stored library data and compare the extracted identifiers with stored library data.

In one embodiment, microprocessor 24 might formulate a query such as a database query based on the extracted identifiers, and search the stored medication library data for a match. An example matching process might include formulating a query comprised of the following contextual identifiers: color=X; scoring=Y; shape=Z; ratio of length to width >2; and logo=none. Microprocessor 24 could then search the stored image library data and determine which, if any, of a plurality of stored profiles for individual medications includes contextual identifiers matching all or a threshold number of the contextual identifiers of the query. The stored profiles for individual medications might include stored tables including each of a color coordinate, a scoring coordinate, a shape coordinate, etc. The stored profiles might also include stored images, from which contextual identifiers are extracted and compared with the contextual identifiers associated with the captured image.

From step 108, the process of flowchart 100 may proceed to step 110 where microprocessor 24 may query whether there is a match. This step may be understood as microprocessor 24 determining whether data for the captured digital image appears to match stored data which is indicative of a known medication type. If no match is found, the process may proceed to step 111 to log a fault, or might instead return to attempt an additional match. From step 110, the process of flowchart 100 may proceed to step 112 wherein microprocessor 24 may output a prompt for patient-user confirmation. Such a prompt might include, for example, a text prompt generated via display 26 which requests a patient to confirm that an identified medication is in fact a medication which the patient knows he or she is to take. From step 112, the process may proceed to step 114 wherein microprocessor 24 may query whether the medication identification is confirmed by the patient. If no, the process may proceed to step 115 to log a fault. If yes, the process may proceed to step 116.

At step 116, microprocessor 24 may link patient profile data with medication identification data. This step may be understood as linking locally stored information which is specific to the patient-user of device 12 with information which is specific to an identified medication. For example, step 116 might include linking patient “X” with medication “A-A”. Additional information might be linked at step 116 or via another processing step. For example, linking patient profile data with medication identification data may include but is not limited to linking a listing of additional medications for which the patient has a prescription, other patient health information, or other information specific to the identified medication such as dosage. For example, executing step 116 could include linking patient “X” who is also taking medications “P, Q, R,” with a dosage of “Z pills per day” of medication “A-A” at a dosage of “T” milligrams. From step 116, the process may proceed to step 118 wherein microprocessor 24 may output an administration confirmation request. From step 118, the process may proceed to step 120 to finish, or might proceed to execute additional steps or subroutines related to managing and/or monitoring medication administration or general patient health.

Execution of step 118 may be understood as generating a signal which is transmitted from device 12 to a health services provider, or another entity, who may be requested to confirm that administration of the identified medication in a specified way to the identified patient is correct. In one embodiment, the administration confirmation request might be transmitted wirelessly from transceiver 20 to communications network 14, and then received via remote computing system 16. Remote computing system 16 may autonomously, via a microprocessor, or with the assistance and/or interaction of personnel at remote computing system 16, determine whether self-administration of the identified medication by the patient and/or at an identified dosage is correct. In one embodiment, it may be determined by remote computing system 16, or by personnel at remote computing system 16, if the linked data satisfies a medication-to-patient match criterion. In other words, it may be determined if the identified medication and/or identified medication dosage matches with the identified patient. If the linked data satisfy a medication-to-patient match criterion, an administration confirmation signal may be transmitted from remote computing system 16 to device 12. This signal could prompt device 12 to store dosage and medication type information locally for easy retrieval. If the linked data does not satisfy the medication-to-patient match criterion, a fault may be generated. Generating a fault could include autonomously generating a fault, or a fault could be generated by manual entry at remote computing system 16. Responsive to the fault, a patient alert may be transmitted to device 12 via communications network 14, advising a patient not to take an identified medication, not take the medication as planned, or perform some other positive or negative action such as taking the medication only on an empty stomach or only with food or drink. The patient alert might also include a message to the patient correcting dosage, frequency of administration, or some other correction factor. Under certain conditions transmitting a patient alert may also include transmitting an alert to another health services provider, as further described herein, or advising the patient himself whom to contact to discuss potential problems. In certain embodiments two prescribers of two potentially conflicting medications might both be autonomously notified.

In one further embodiment, it may be determined at remote computing system 16 whether the linked data is indicative of a conflict condition or of a potential conflict condition. Numerous potential conflict conditions are contemplated herein such as a medication interaction conflict, a medication dosing conflict, or a medication recall conflict. A fault may be generated via remote computing system 16 responsive to a determined conflict condition. A database which includes at least one of, medication interaction data, medication dosing data, and medication recall data, may be stored at remote computing system 16 or accessible from remote computing system 16, such that the database may be queried autonomously or by personnel at remote computing system 16 to determine if the linked data is indicative of a conflict condition. Rather than performing the determination of a conflict condition at remote computing system 16, in other embodiments device 12 could perform this operation. As alluded to above, a patient alert may be generated by device 12 or transmitted to device 12 responsive to determining a conflict condition exists. Alerts may also be transmitted to a health services provider. For instance, if a medication interaction conflict condition is determined to exist, an alert may be transmitted to computing systems at each health services provider for the patient-user of device 12.

The foregoing described embodiments discuss managing patient self-administration of medication. The present disclosure also contemplates further applications for the use and processing of digital images of medication. Patient health information other than just medication information may be of interest. In one particular embodiment, microprocessor 24 may output a medication information signal responsive to capturing a digital image of medication via imaging device 22. The medication information signal may include medication identification, medication dosing, or other information. The medication information signal may be transmitted from transceiver 20 to communications network 14 for receipt by a remote computing system, or instead the medication information signal might be processed locally. In either case, it may be determined that an action condition exists responsive to the medication information signal. One action condition could include a determination that a patient has received the wrong medication or the wrong dosage of medication. Responsive to a determined action condition, a patient alert may be generated by device 12 or transmitted to device 12.

In other embodiments, determining an action condition exists may include determining a research suitability condition exists responsive to a medication information signal. For example, it may be determined, based on a medication identification datum and a patient identification datum contained in the medication information signal, that the patient-user of device 12 is suited for participation in a clinical research study. To this end, once it is determined that the patient-user is prescribed or taking a particular medication, a patient profile based on the stored profile data for the patient may be compared with a research profile. Where profile data for the patient matches research profile data, a patient alert which includes a research participation request may be generated.

It will be recalled that the profile data for the patient-user of device 12 stored on memory 30 may include a variety of different types of data. Such data may include, for example, food and drink data, exercise data, or even travel data. A patient's activities in relation to traveling to or from their home may be electronically stored on memory 30. Device 12 might be equipped with global positioning system software, accelerometers, or other software and/or hardware, to enable logging patient location and/or travel data. Microprocessor 24 may be further configured to generate patient alerts or prompts responsive to the stored data. This might include, for example, prompting the patient-user to take a particular medication, or stop taking a particular medication. Simple reminders to take medication based on a determination that the patient-user is not traveling, for example driving, may be generated responsive to the stored data. Profile data used to generate such alerts/prompts may be acquired, for example, by prompting the patient user to enter prescribing information such as medication dosage, administration frequency, and administration conditions such as: with water; with food; not while driving; etc. Microprocessor 24 may, based on the stored data, “intelligently interrupt” the patient and prompt him or her to take their medication, based on comparing real time data with the stored data. These interruptions might be created based on stored patterns of behavior of the patient. Thus, the interruptions might change timing as microprocessor 24 learns the dietary, travel, sleep, and activity patterns of the patient, and thus prompt the patient to take medications at optimal times in their daily routines, for instance. Contextual information might also be used to detect deviations from normal patterns such that a reminder to take medication, for example could be delayed if appropriate. Still other information such as sugar or alcohol intake could be gathered by patient self-reporting and used to time or modify the timing of medication reminders or other interruptions. Still other uses of intelligent interruptions might include reminders to wake, go to bed, eat or drink, etc., apart from administration of medication. Local storage of the private patient administration is expected to allay concerns as to sharing personal or potentially embarrassing information. In other words, in at least certain embodiments, all data apart from dosage and medication type can be stored on device 12, protecting patient privacy.

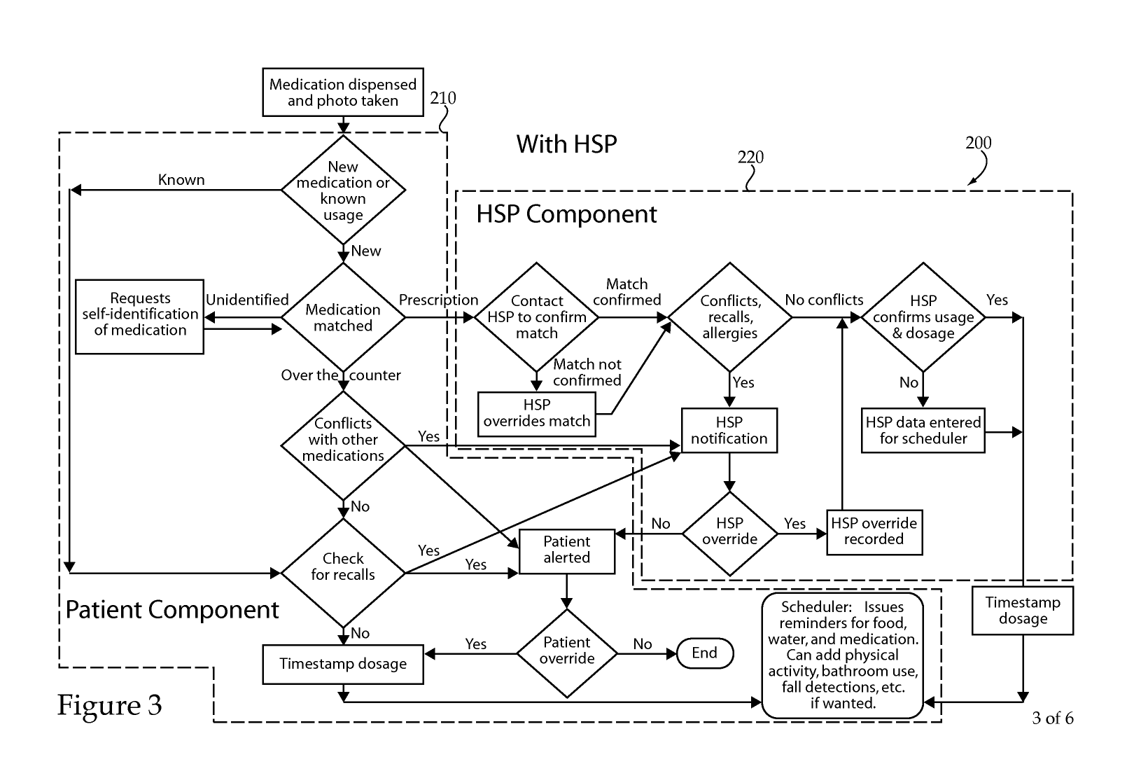

Referring to FIG. 3, there is shown another flowchart 200 illustrating an example process according to the present disclosure. Flowchart 200 includes a plurality of different steps, some of which may be executed either electronically by device 12 or remote computing system 16 or by health services provider personnel or the patient-user of device 12. The steps of flowchart 200 may be understood as including a patient component 210 and a health services provider component 220. The process of flowchart 200 includes various steps analogous to those described above in connection with the process of flowchart 100, but also including additional subject matter. It may be noted that determining the existence of conflicts may take place locally, within component 210, or remotely, within component 220. It may further be noted that a patient alert may be generated either locally within component 210 or remotely within component 220 in response to conflicts such as medication interaction conflicts, recall conflicts, or allergy conflicts. It may further be noted that timestamps are executed in both component 210 and component 220, and that a Scheduler is part of component 210 and receives data generated within component 210 as well as data generated within component 220. The Scheduler may be understood as a software routine executed by microprocessor 24 which, similar to the description above, can issue reminders for food, water, and medication, to the patient-user of device 12, as well as recording bathroom use, falls, sleeping patterns, and other patient activities or conditions. It may still further be noted that, where a new medication or a known usage condition exists, the medication matching procedure may be skipped. This may be the case where, for example, a patient does not wish to use or does not need to use the electronic matching and self-administration management protocols described herein. It might also be the case where a new medication is prescribed, and the stored medication library on device 12 has not yet been updated to enable identification of the new medication.

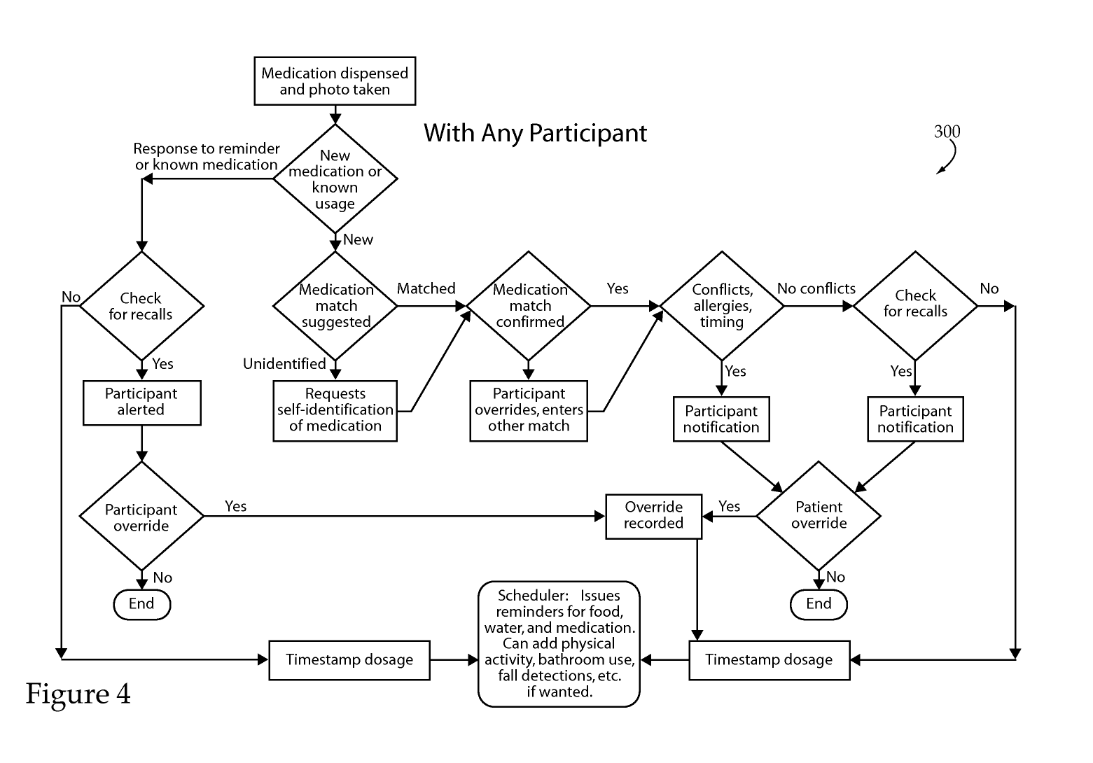

Referring to FIG. 4, there is shown another flowchart 300 illustrating steps in an example process which need not include participation of both a patient and a health services provider. The process of flowchart 300 may include a medication-to-patient match procedure which does not require communication between different computing systems.

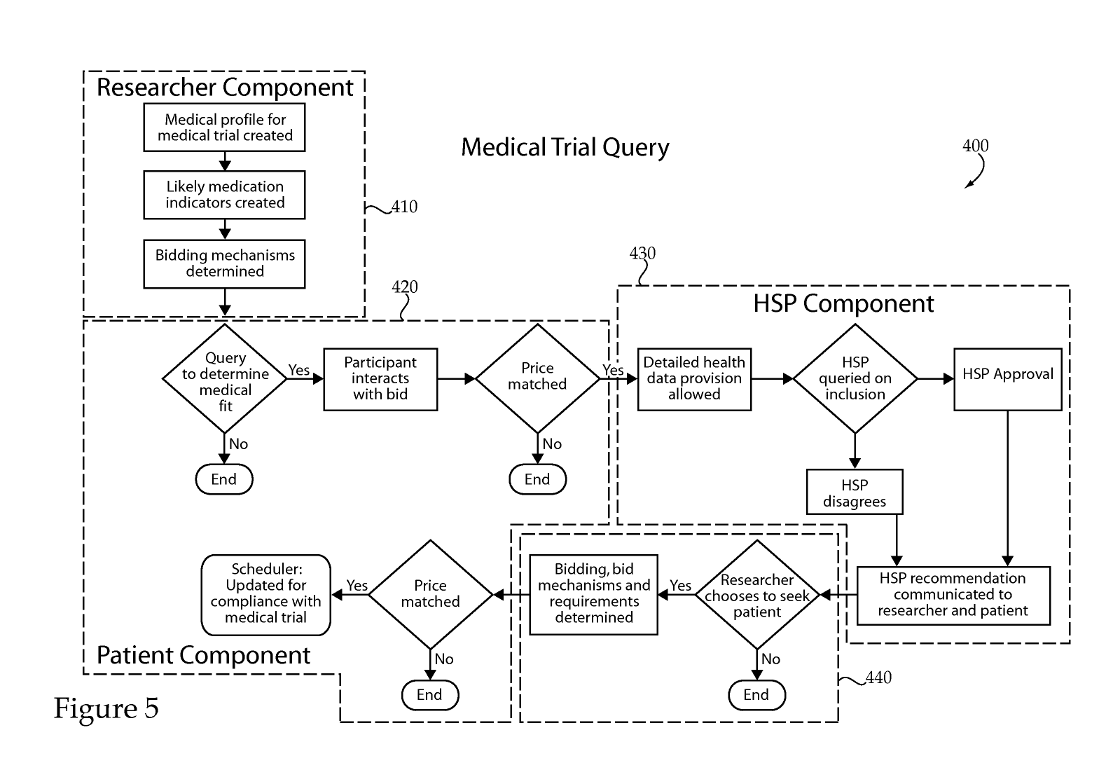

Referring to FIG. 5, there is shown another flowchart 400 illustrating example steps in a process including a researcher component 410, a patient component 420, a health services provider component 430, and a fourth component or contact component 440. The steps and components of flowchart 400 are similar to those discussed above in regard to locating potential participants in clinical research. Component 410 includes a step of creation of a medical profile for a medical trial, and a step of creation of likely medical indicators. The likely medical indicators may be understood as “flags” which may be indicative of a patient being a potential prospect for participation in a research study. The medical profile may include a prescribed medication criterion in one embodiment. In other words, one component of the medical profile might be a requirement that a potential participant be taking or planning to take a particular prescription medication. Over the counter medication might also be used. These steps may be understood as analogous to creation of a research profile as discussed above. Similarly, component 420 includes a step of querying to determine medical fit, corresponding to comparing a patient profile with a research profile, as discussed above. This query may include an oblivious query in certain embodiments, protecting the privacy of all parties. One requirement of a medical fit may be a determination that a patient is prescribed a particular medication. A medical fit may be determined, for example, where stored profile data for a patient includes a medication identification data which matches with a medication which is a component of the medical profile associated with the medical trial. A Scheduler is also included in component 420, and may include an updating function to enable reminders and the like to be provided to a patient in conformity with the requirements of a particular clinical research study. It may further be noted that component 410 includes a step of determining bidding mechanisms, and that component 420 includes a step of the participant/patient interacting with a bid. In other words, a participant or potential participant may decide whether to accept a bid price. If a price is matched, then the process may proceed to obtain the interaction of a health services provider in component 430. A health services provider may participate via component 430 and provide recommendations to a patient, for example recommendations communicated to both a researcher and patient based on whether a patient should be included in a particular clinical research study. A patient may also authorize detailed health data to be sent to or accessed by the researcher. Fourth component 440 illustrates steps involved in contacting the patient should such contact be allowed and/or desired. In one embodiment, the patient-user of device 12 may be advised of proposed inclusion in a clinical research study, decide whether they want to participate and for what compensation, and obtain the approval or disapproval of their health services provider, all by way of interaction with device 12. The patient user may also be advised as to potential risks, potential benefits, and other factors related to participation in a proposed study. Another way to understand procedures in flowchart 400 is that a patient's informed consent may be obtained. This can occur without the need for a patient to communicate personal information to a third party, in contrast to server based strategies in which patients are typically required to input personal information before they can be considered for clinical trials. In the present case, pertinent information can remain locally stored, although if desired a query from a researcher could include an authorization request to access data stored on device 12.

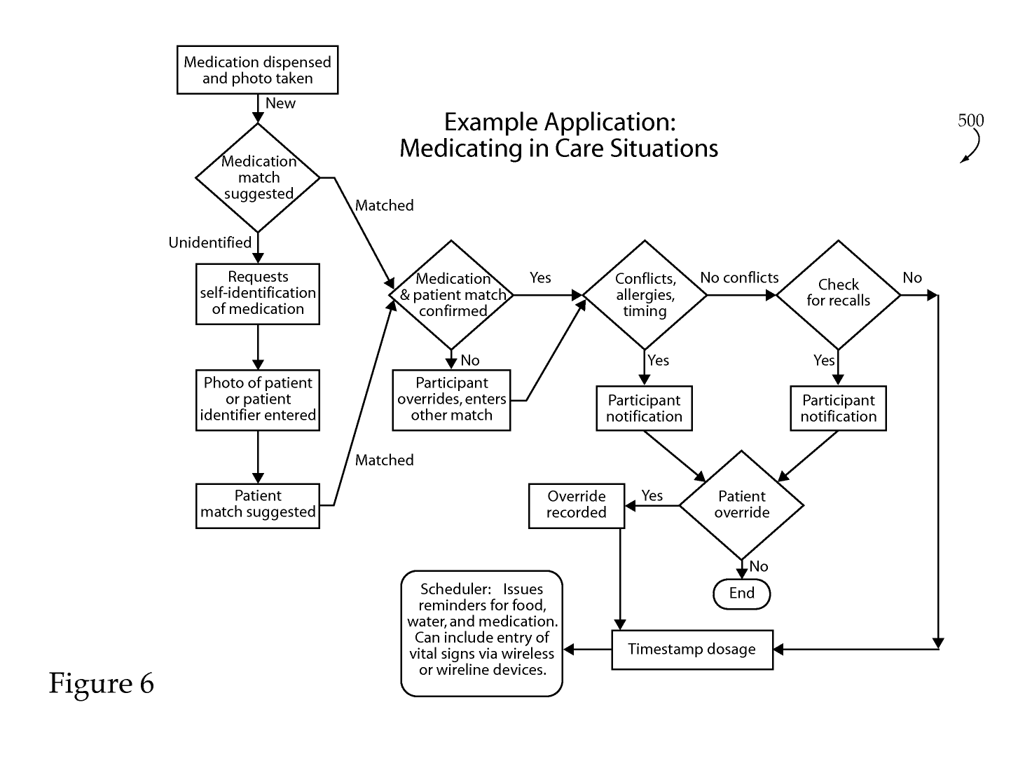

Referring to FIG. 6, there is shown another flowchart 500 illustrating an example process for medicating in a care situation. In one embodiment, the process of flowchart 500 may take place in a hospital, nursing home, or clinic where a patient is resident. The process of flowchart 500 includes execution of various steps similar to those described in connection with the other embodiments herein. It may be noted that the process of flowchart 500 includes subject matter of matching a particular patient to a particular medication based on entry of an image of a patient. This step of matching could take place electronically, or could be performed by personnel employed by the hospital, etc.

Each of the example embodiments described herein may be understood as advantageously using digital image data of a medication. It will be recalled that a number of different contextual identifiers may be extracted from a digital image of a medication, and compared with stored library data to identify the subject medication. It is contemplated that interaction with the identification process by a patient-user of a personal computing system, or interaction by a health services professional, will be used to further validate identity of a medication, conflict conditions or other concerns associated therewith. In other words, preliminary identification of a medication may take place electronically, and this preliminary identification may be validated by way of human involvement. The general procedure used to match a digital image or image data for a captured digital image of medication with library data may take place by way of any known or to be discovered scanning or imaging technique. For example, a template similar to that discussed above which includes a medication size factor, shape factor, scoring factor, color factor, and possibly other factors may be established. Each digital image of medication may be processed to extract these factors and populate the template, which is then compared with another template populated from stored library data to determine if a match exists. While this general approach provides one practical implementation strategy, alternatives are contemplated, such as the use of strategies known from the field of machinery parts recognition, and the present disclosure should thus be understood as not limited to any particular technique for establishing the identity of a medication.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of managing patient self-administration of medication comprising the steps of:
receiving image data associated with an image of a medication captured by a digital imaging device of a personal computing system;
comparing the image data with stored medication library data;
linking profile data for a patient-user of the personal computing system with identification data for the medication, responsive to comparing the image data; and
outputting an administration confirmation request from the personal computing system which is based on the linked data.

2. The method of claim 1 further comprising a step of prompting the patient-user to confirm a medication identification, prior to the outputting step.

3. The method of claim 1 wherein:
the step of comparing further includes comparing the image data via a microprocessor resident on the personal computing system; and
the step of outputting further includes a step of transmitting the administration confirmation request from the personal computing system to a remote computing system via a communications network.

4. The method of claim 3 further comprising the steps of:
receiving the administration confirmation request via the remote computing system;
transmitting an administration confirmation from the remote computing system to the personal computing system via the communications network, if the linked data satisfies a medication-to-patient match criterion; and
generating a fault, if the linked data does not satisfy the medication-to-patient match criterion.

5. The method of claim 4 further comprising a step of transmitting a patient alert to the personal computing system via the communications network responsive to the fault.

6. The method of claim 5 further comprising a step of determining the linked data is indicative of a conflict condition via querying a database which includes at least one of, medication interaction data, medication dosing data, and medication recall data, and wherein the step of generating a fault includes generating the fault responsive to a determined conflict condition.

7. The method of claim 6 further comprising the steps of electronically reading each of the medication library data and the profile data for the patient from a local storage medium.

8. A method of managing patient health information comprising the steps of:
capturing a digital image of a medication via an imaging device resident on a personal communication device;
outputting a medication information signal responsive to capturing the digital image, via a microprocessor resident on the personal communication device;
determining an action condition exists responsive to the medication information signal; and
generating a patient alert via the personal communication device responsive to a determined action condition.

9. The method of claim 8 further comprising a step of identifying the medication at least in part by comparing image data for the captured digital image with library data stored on a computer readable memory resident on the personal communication device.

10. The method of claim 9 further comprising a step of transmitting an administration confirmation request for the identified medication from the personal communication device to a remote computing system.

11. The method of claim 9 further comprising a step of electronically storing profile data for the patient on the computer readable memory, the profile data including a patient identification datum, a medication identification datum, and a medication dosing datum.

12. The method of claim 11 wherein:
the step of determining further includes determining an action condition which includes a conflict condition exists, responsive to identifying the medication; and
the step of generating a patient alert further includes generating a patient alert responsive to a determined conflict condition.

13. The method of claim 12 wherein the step of determining further includes determining existence of a medication interaction conflict, a medication dosing conflict, or a medication recall conflict.

14. The method of claim 9 further comprising a step of electronically storing profile data for the patient which includes a medication identification datum on the computer readable memory;
the step of determining further includes determining an action condition exists which includes a research suitability condition at least in part via a step of comparing the profile data for the patient with research profile data; and
the step of generating a patient alert further includes generating a research participation request.

15. The method of claim 8 further comprising a step of electronically storing profile data for the patient which includes a history of patient activities on the computer readable memory, and wherein the step of generating a patient alert further includes generating a patient alert responsive to the stored profile data.

16. A patient health management system comprising:
a personal computing system including a transceiver configured to receive and transmit signals with a communications network, a digital imaging device, and a microprocessor in control communication with the transceiver and the digital imaging device;
the personal computing system further including a computer readable memory storing computer executable code comprising a medication management routine;
the microprocessor being configured to store medication library data on the computer readable memory, and configured via executing the medication management routine to compare the medication library data with image data associated with a digital image of a medication captured by the digital imaging device; and
the microprocessor being further configured to link profile data for a patient-user of the personal computing system with identification data for the medication, responsive to comparing the medication library data with the image data, and output an administration confirmation request via the transceiver which is based on the linked data.

17. The system of claim 16 wherein the transceiver includes a wireless transceiver, and wherein the personal computing system includes a portable wireless communication device which includes a housing having each of the transceiver, the digital imaging device, and a battery positioned therein.
